(19) United States
(12) Patent Application Publication
(10) Pub. No.: US 2010/0290016 A1
(43) Pub. Date: Nov. 18, 2010

(54) MICRODEVICE FABRICATION

(76) Inventors: Bryan Kaehr, Austin, TX (US); Rex Nielson, Austin, TX (US); Jason B. Shear, Austin, TX (US)

Correspondence Address: Baker Botts L.L.P, 910 Louisiana Street, One Shell Plaza, HOUSTON, TX, 77002, US

(21) Appl. No.: 12/811,532

(22) PCT Filed: Jan. 2, 2009
(86) PCT No.: PCT/US09/30013

§ 371 Date: Jul. 2, 2010

Related U.S. Application Data
(60) Provisional application No. 61/018,599, filed on Jan. 2, 2008.

(51) Int. Cl. G03B 27/68; G03B 27/32

(52) U.S. Cl. 355/52; 355/77

(57) ABSTRACT

According to certain embodiments, systems comprising an energy source; at least one conjugate mask; a magnification device; and a fabrication material; wherein the at least one conjugate mask is disposed between the energy source and the magnification device; and wherein the fabrication material is disposed operable to the magnification device. According to other embodiments, methods and composition employing such systems.

### CROSS-REFERENCE TO RELATED APPLICATIONS

This application claims the benefit of U.S. Provisional Patent Application Ser. No. 61/018,599, filed Jan. 2, 2008, the entire disclosure of which is hereby incorporated by reference.

### STATEMENT OF GOVERNMENT INTEREST

The present invention was made with government support from the National Science Foundation (Grant No. 0317032). The U.S. Government has certain rights in the invention.

### BACKGROUND

Currently, there is a significant interest in methods of fabricating and evaluating small-scale devices for use in applications including cellular patterning, neuronal circuit engineering, stem cell research, cell biosensors, cell-powered machines, and microfluidic and micromechanical devices. As a result of this demand, a variety of techniques have been developed to fabricate such devices.

Methods such as photolithography, which include the use of X-rays or deep ultraviolet rays, are well known methods for producing two-dimensional microstructures. Methods for microscale fabrication based on microcontact printing and modification of surface chemistry with self-assembled monolayers have also been developed. Both of these methods, however, are severely limited in their ability to produce arbitrary three-dimensional structures, which are of particular interest. Additionally, the structures produced by these methods often have limited biocompatibility.

Several methods have been developed to address this interest in three-dimensional structures, including biomimetic matrix topography and two-photon or multiphoton lithography. Biomimetic matrix topography produces three-dimensional structures by removal of an epithelial or endothelial layer from a biological surface to expose the supporting basement membrane or matrix, followed by use of the basement membrane or matrix as a mold for polymer casting. The cast polymer is then used as a negative for biomaterial casting. This technique, however, requires the use of a biological surface, which limits the topography of the structures that can be produced from such a method.

Multiphoton lithography is a technique in which a laser beam is scanned across a substrate, usually coated with a polymer resin containing a unique dye, to create a desired hardened polymer structure. The laser writing process takes advantage of the fact that the chemical reaction of cross-linking occurs only where molecules have absorbed multiple photons of light. Since the rate of multiphoton-photon absorption decreases rapidly with distance from the laser's focal point, only molecules very near the focal point receive enough light to absorb two photons. Therefore, such methods allow for significant control over the topography of the produced structure. Such methods, however, currently require expensive and highly specialized processes, as well as economically significant amounts of time and materials to produce prototypes of such devices.

### SUMMARY

In order to fabricate and evaluate complex three-dimensional microstructures in an economical and time-effective manner, methods must be provided that allow for the fabrication of such devices without the use of highly specialized equipment. Furthermore, in order for such microdevices to be broadly useful in the biological sciences and other related fields, such methods must allow for the use of diverse materials. The present disclosure, according to certain embodiments, relates to a mask-directed lithography systems and methods that provide the means to create complex three-dimensional nano- and microstructures using a facile process amenable to rapid prototyping and iteration. The present disclosure, according to certain embodiments, also provides compositions formed using such methods and systems.

The features and advantages of the present invention will be readily apparent to those skilled in the art upon a reading of the description of the embodiments that follows.

### DRAWINGS

Some specific example embodiments of the disclosure may be understood by referring, in part, to the following description and the accompanying drawings.

FIG. 1 shows placement of a mask object (housefly in left panel; scale bar, 2 mm) in a plane conjugate to the front focal plane of the microscope objective directs fabrication of the object negative using bovine serum albumin, BSA, and methylene blue as a photosensitizer (montage of differential interference contrast [DIC] images, center panel; scale bar, 20 μm) using multiphoton lithography. Regions demarked 1 and 2 in this image are shown in detail in scanning electron micrographs, SEMs (right panels; scale bar, 1 μm).

FIG. 2 shows a two-tiered BSA microstructure fabricated using two separate masks sequentially (A). The overlap region shunts bacteria from the ground floor to the second floor loft. (B) SEM of the resultant two-tiered BSA microstructure. (C) DIC images showing E. coli cells (RP9535) entering and transiting the ground floor passage (left panel) to the overlap region (arrow, middle panel) and up to the loft (right panel), which ultimately becomes filled with cells (inset). Scale bars (B, C) are 5 μm.

FIG. 3 shows biocompatible microfabrication to trap a single bacterium. (A, B) SEM images of a BSA microcontainer similar to that shown in parts C and D. (C) SEM of a BSA container after the entrance was plugged with a bacterium inside. (D) Sequence showing a BSA container before (1) and immediately after (2) fabrication of a plug to trap a bacterium (arrow; scale bar, 10 μm.). Cell division eventually fills the trap with no loss of bacteria (3-6). Time points are (3) 172 min, (4) 360 min, (5) 590 min, (6) 16 h. Scale bars are A/D, 10 μm; B/C, 2

FIG. 4 shows use of a moving mask to create a gradient in both thickness and chemical functionalization across a protein microstructure. A gradient microstructure was fabricated from a solution containing 90% BSA and 10% avidin (wt/wt; total protein concentration was 320 mg mL-1) and methylene blue (3 mM). During laser scanning, a fully opaque straight-edge mask was translated such that its image in the fabrication plane was swept at a rate of 2 μm s-1. The resultant BSA/avidin microstructure was incubated in 2 μM fluorescein biotin for 10 min, rinsed 10 times in phosphate-buffer saline, PBS (pH 7.0), and imaged via fluorescence. (A, B) DIC and SEM microscopy reveal that changes in laser exposure times across the protein structure cause a thickness gradient. (C) Plot (green line) representing the fluorescence intensity of a horizontal line drawn across the structure (from arrow). This intensity was divided by the thickness of the structure (inset) to yield the functional gradient density (i.e., normalized for structure thickness). From this data, the fluorescence intensity gradient is shown to be a convolution of structure thickness and functional density (i.e., biotin binding capacity of avidin). Panel D is a 3D surface intensity plot of the fluorescent image in panel C and shows that the gradient is maintained across the surface of the microstructure.

FIG. 5 shows translatable masks produce microgradients in microstructures. (A) The direction of the gradient slope can be dictated by the direction of mask translation orthogonal to the beam axis (e.g., west to east, [left structure]; south to north, [right structure]; east to west, [bottom structure]. This approach is useful for creating functional microgradients, as well as gradients of protein and photosensitizer. (B) Actuation (from closed to open) of a variable aperture iris during fabrication produces a radial microgradient. (C) Microgradient boundaries can be defined with a stationary negative mask. Here linear (lower inset) or nonlinear gradients (along the dotted arrow) are fabricated using masks translated at linear and accelerated velocities respectively. The plot shows the gradient profile along the direction of the dotted arrow in C, produced by translating an opaque mask of dimensions smaller than the negative transparency used to define the microstructure edges. All microstructures were fabricated from 400 mg ml-1 BSA photosensitized using 5 mM methylene blue. Fluorescence intensity is from entrapped photosensitzer. Scale bars, 5 μm.

FIG. 6 shows rapid prototyping using MDML. (A) A scheme for the rapid prototyping of a microchamber for the directed motility of motile bacteria. In the process of fabricating the chamber, multiple planes of the structure are created in sequence by scanning the mask, stepping the position of the focal point to a different depth in the reagent solution, and repeating the scan. This process can be repeated to create a microstructure of the desired height. (B) This approach allows rapid iteration and fabrication of arbitrary microchamber geometries. Microchambers are ˜5 μm tall and tops are sealed by scanning the laser beam without a photomask in place. Scale bars, 15 μm.

FIG. 7 shows a schematic for one embodiment of DMD (digital micromirror device)-directed multiphoton lithography. Dotted lines (“beam translation”) denote the limits of the scan position of the beam axis. L1-4 designates the position of lenses.

FIG. 8 shows DMD-directed MDML for fabrication of multiple vertical planes of an image stack comprised of horizontal planes from a human head MRI scan directs fabrication of an acrylate microreplica. Numbers denote the position of the mask in the total sequence of masks used to direct fabrication (total=150). Scale bar, 5 μm.

FIG. 9 shows one embodiment for DMD-directed MDML for horizontally “quilting” structures, allowing rapid fabrication of structures larger than can be achieved with a single horizontal scan plane (a) The image is divided into segments for comprising a sequence of horiztonal scan planes (using the program Labview). (1) Shows the segmented regions. (2) Depiction of expansion of segmented regions (now labeled by order of fabrication). (3) Depicts the amount of overlap between fabricated structures. (4) Shows the finished structure stitched together from eight separate masks. (b) Eight-segment quilted structures made from JPEG files. From left: model of caffeine, flycatcher on wire, and Shear Lab logo. Scale bars, 10 μm.

FIG. 10 shows micro-reconstructions of biological organisms fabricated using DMD-directed MDML. The synchronization of DMD image sequences (high resolution X-ray CT data provided by digimorph.org) with vertical sample plane steps enables animal (a-e) and pincushion protea (f, top) replicas, composed of photocrosslinked BSA, to be fabricated rapidly (1-2 s plane-1). Panel f also shows predicted (left) and actual fluorescence images (right) of a protein protea acquired during fabrication (side view) and postfabrication (top view).

FIG. 11 shows mask-truncation produces sectioned microstructures. Truncation of DMD-displayed images in a coronal stack produces sagittal sectioning of chimpanzee skulls composed of photocrosslinked BSA (a, left and right). Subtracting sequential planes from the complete image sequence results in horizontally sectioned microstructures (b; inset shows top view). Scale bars, 10 μm.

FIG. 12 shows a simple mask sequence can create a complex 3D object. Left: SEMs of a protein microbraid fabricated using 150 sequential planes, each spaced using 1 μm vertical steps. The mask data for each plane was an animation of three circles moving in interlocked ‘FIG. 7’ patterns. Right: Predicted 3D reconstruction based on mask images. Microstructures were fabricated using 400 mg mL-1 BSA and 5 mM methylene blue. All scale bars, 10 μm.

FIG. 13 shows prototyping of a microarchitecture for directing cell motility and molding 3D cell colonies. a. 3D reconstruction (based on mask images) of a microchamber prototype with a single entrance into a spiral ramp (20° pitch, 270° twist) leading up and into the top-front of the enclosed central receptacle (labels are dimensions in micrometers). b. SEMs of microchamber prototypes with intact (top left panel) and sectioned (top right and bottom panels) tops. c. DIC image sequence of a single, smooth-swimming E. coli bacterium (enclosed by oval) that passes the entrance and is directed up the spiral passage. Dotted line denotes the top edge of the passageway; elapsed time for sequence is 1 s. d. Overnight incubation in T-broth of E. coli within the microchamber (from panel c) results in growth of a molded cell colony conforming to the shape of the internal architecture. Insets show a schematic of the cell colony and position of focus for each panel. All structures were fabricated from solutions of BSA in ˜2 min. using a sequence of 120 masks, with the specimen stepped by 0.3 μm along the optical axis between masks. Nominal structure height (c and d), 32 microns. Scale bars, 10 μm.

FIG. 14 shows fabrication of BSA gradient rods for microactuation using MDML. (a) Laser scanning within fabrication solution produces a material gradient along structure edges (as in panel 1). This “edge effect” is produced by longer laser dwell times at pattern edges during raster scanning. By placing an opaque photomask in a plane conjugate to the fabrication plane (i.e., MDML), the central region of the structure (the “masked region” in panel 1) would be eliminated, leaving only scan edges (“unmasked regions” in panel 1). In this way, rods are created from scan-edge regions that have material gradients along their widths, a procedure that yields definable bending capacities. Panel 2 shows rods created by leaving unmasked only the left scan edge (“L”) or right scan edge (“R”). Unmasked regions are translated by the microscope stage at 1 μm/s in a direction orthogonal to raster scanning (performed at 500 Hz) to create surface-tethered rods (points of attachment are located near the dashed line; see Methods section for more details). Panel 3 shows rod curvature after treatment with a pH 2.2 (HCl) rinse. Scale bars, 3 μm. (b) Scanning electron micrographs (SEMs) reveal a thickness gradient along the edge of a rod. Earlier studies indicate that density gradients can accompany thickness gradients for protein microstructures irradiated differentially (Ref 20). (c) SEMs showing a PMMA microsphere tethered to the surface with a gradient rod. Scale bars, 3 μm.

The patent or application file contains at least one drawing executed in color. Copies of this patent or patent application publication with color drawing(s) will be provided by the Office upon request and payment of the necessary fee.

While the present disclosure is susceptible to various modifications and alternative forms, specific example embodiments have been shown in the figures and are described in more detail below. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure, according to certain embodiments, generally relates to systems and methods for nano- and microstructure fabrication.

The present disclosure provides, in certain embodiments, a system for three-dimensional fabrication comprising: an energy source; at least one conjugate mask; a magnification device; and a fabrication material; wherein the conjugate mask is disposed between the energy source and the magnification device; and wherein the fabrication material is disposed operable to the magnification device. As used herein, conjugate mask refers to a mask placed in a focal plane having an approximate one-to-one mapping of spatial positions to a fabrication plane. In operation, energy is emitted from the energy source, through the magnification device, and to a fabrication material (see, e.g., FIG. 1). The conjugate mask at least partially blocks the energy emitted from the energy source which contacts it. Thus, differing properties of the mask are translated to the fabrication material enabling the fabrication of structures with a variety of features.

The energy source may be any source capable of inducing change in a fabrication material. Accordingly, the energy source chosen will depend on the particular application and fabrication material. One example of a suitable energy source is a laser light source. Such lasers may include, but are not limited to, a femtosecond titanium/sapphire or frequency-doubled Q-switched Nd:YAG laser. The energy source is directed to the conjugate mask, and may be focused on the conjugate mask and/or spatially scanned at the position of the conjugate mask, as described in more detail below.

In some embodiments, the energy source may comprise one or more laser beams. Such configurations allow simultaneous scanning across different regions of a conjugate mask. In this way, different regions of a microstructure/microdevice can be fabricated in parallel. This approach can be used, for example, to decrease the fabrication time required to create a given spatial pattern.

In some embodiments, the system may further comprise a beam-scanning device. The beam-scanning device, among other things, allows scanning the incident energy to multiple positions of the conjugate mask. Furthermore, the energy from the energy source may be scanned in various manners, including in a rectangular raster fashion, in a circular fashion, randomly, etc. Suitable beam scanning devices are known in the art and include, but are not limited to, galvinometer-driven mirrors and acousto-optic deflectors.

The conjugate mask is disposed between the energy source and the magnification device. The mask should at least partially block the transmission of energy from the energy source to the magnification device and/or fabrication material. The conjugate mask may be a static mask (e.g., physical objects and photomasks), or a dynamic mask (e.g., a device capable of spatially patterning energy from the energy source to present a shape that can be transferred to the fabrication material by the magnification device).

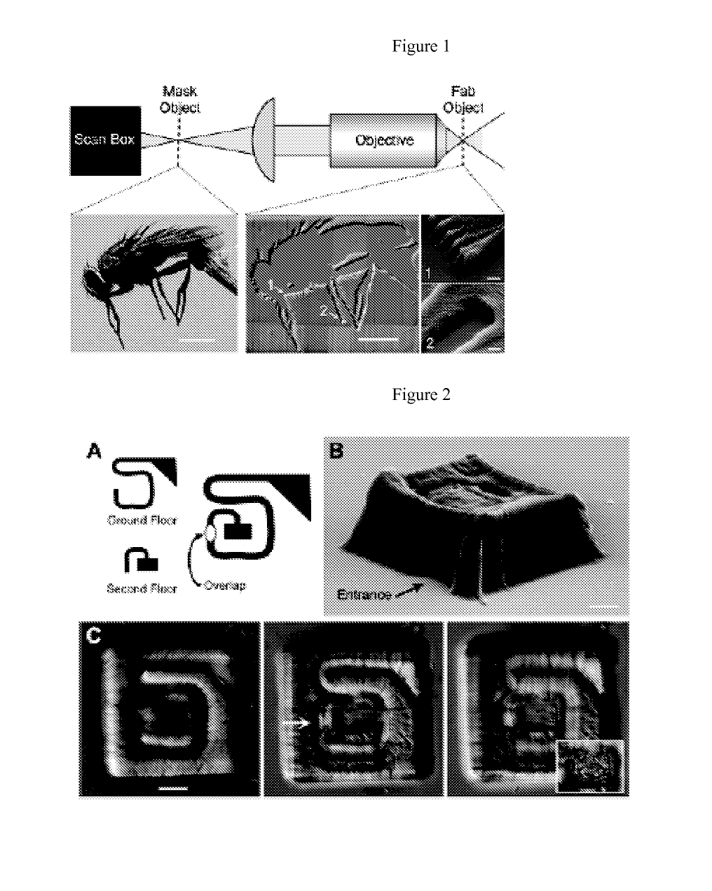

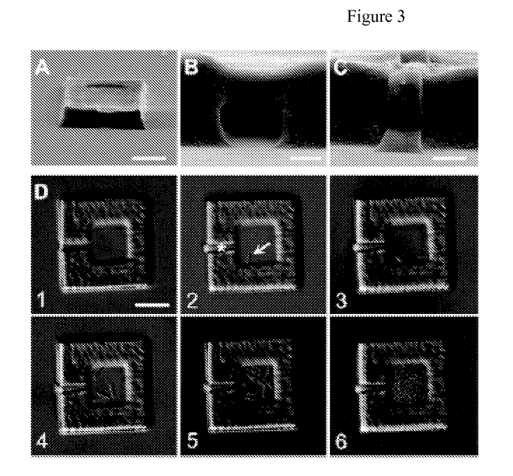

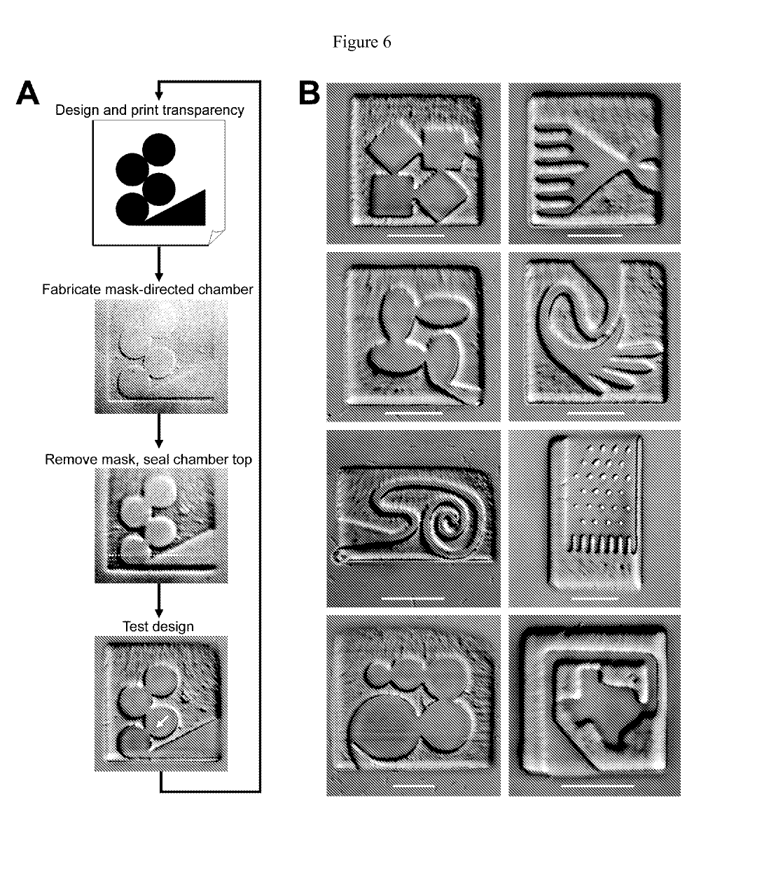

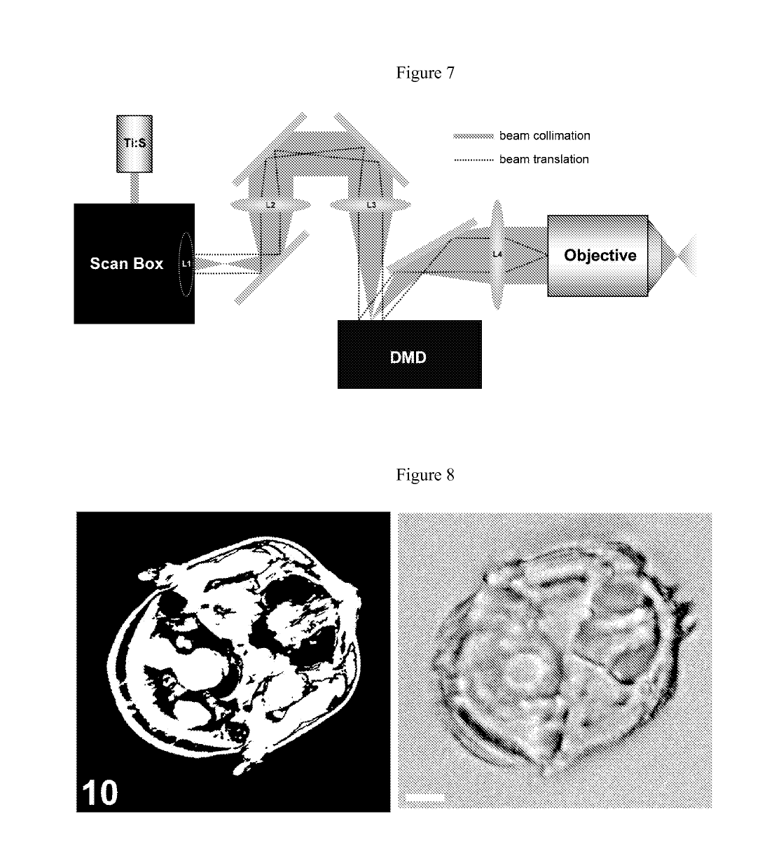

Static masks, such as photomasks and physical objects, may be considered static in that they are fixed with respect to the pattern they present. As discussed below, however, static masks may be moved during fabrication relative to the fabrication material, allowing, for example, for the fabrication of gradients of material (see FIGS. 2, 5, 6). In contrast, dynamic masks are not fixed with respect to the pattern they present. Dynamic masks generally are electronically controlled, among other things, to allow for digitally defined masks (i.e., digital masks) to be rapidly created, processed, and modified by, for example, the graphic output of a computer.

In certain embodiments, the conjugate mask may be a photomask (e.g., an opaque plate with holes or transparencies that allow light to shine through in a defined pattern). Suitable photomasks also may have portions that are neither fully opaque nor fully transparent, but allow some fraction of the incident light to pass through. Partially transparent masks could be useful, for example, in creating gradients. Suitable photomasks also may be transmissive or reflective in whole or part.

In certain embodiments, the conjugate mask may be a physical object, the shape of which is transferred to the fabrication material. Three-dimensional physical objects may extend significantly along the optical axis, although a substantive portion may be positioned with approximate one-to-one spatial mapping with the fabrication plane

As noted above, the conjugate mask may be a dynamic mask. Examples of suitable dynamic masks include, but are not limited to, electronically and optically addressed spatial light modulators using reflective and/or transmissive elements. Examples of reflective elements include, but are not limited to, micromirror devices, liquid crystal displays, diffractive gratings, diffractive optical elements, and reflective light valves. Examples of transmissive elements include, but are not limited to, liquid crystal displays and transmission light valves.

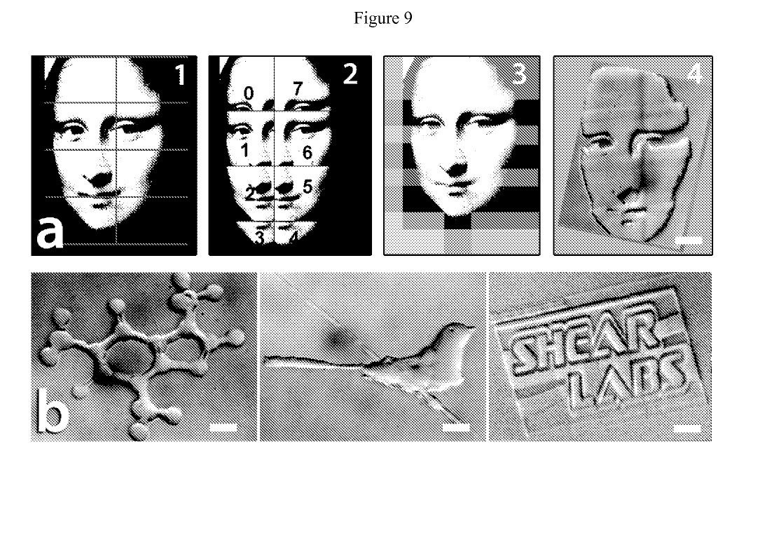

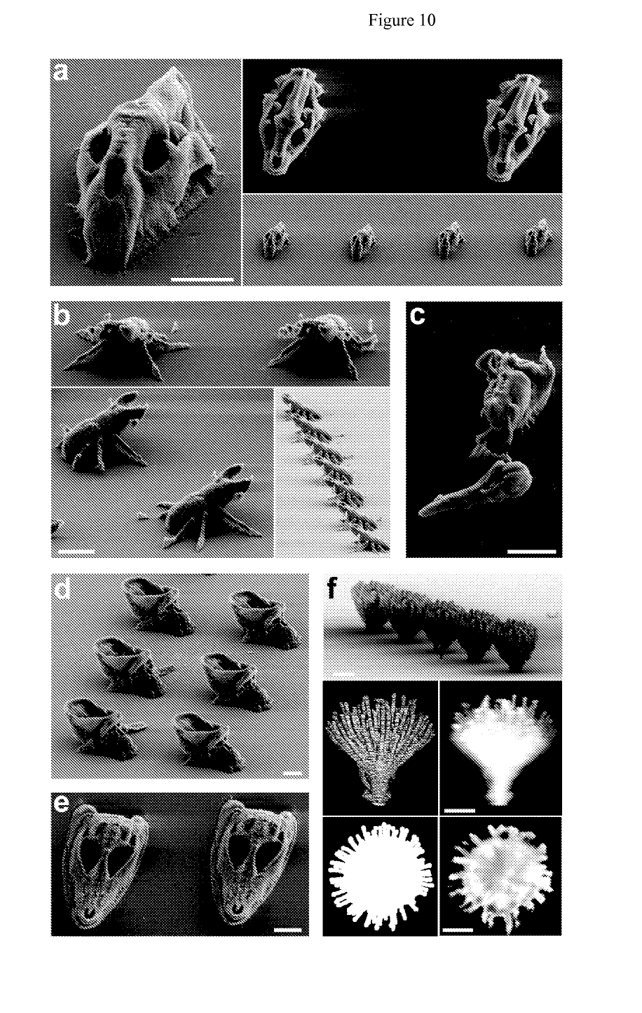

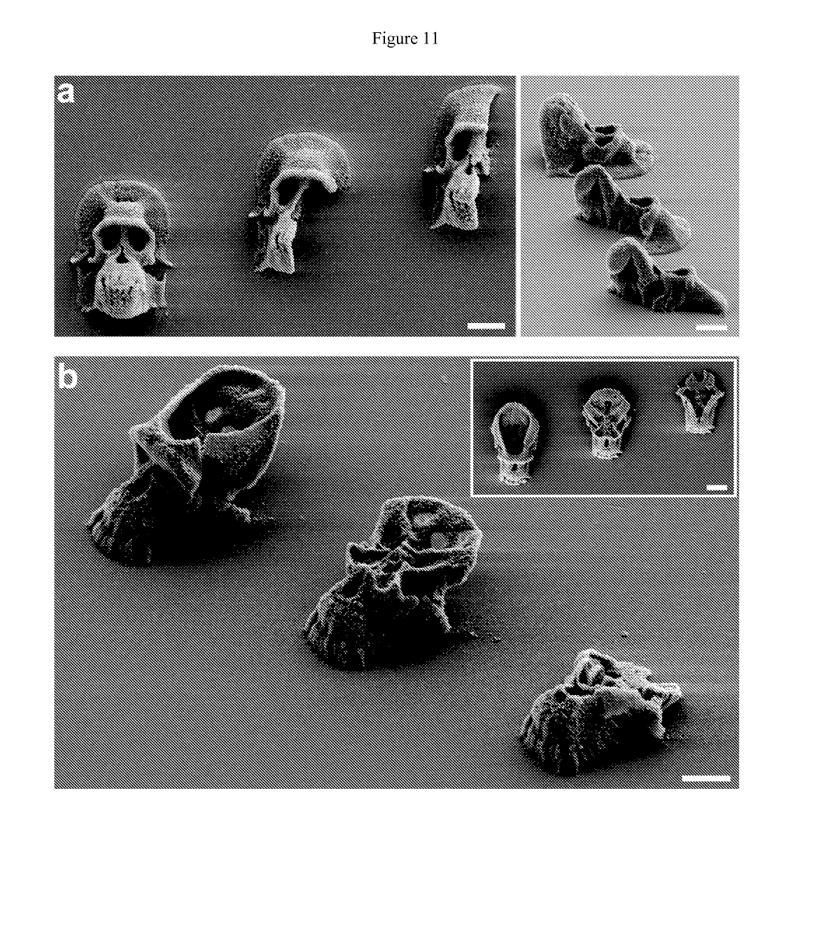

Because dynamic masks may be electronically controlled, they may allow for digitally defined masks to be rapidly created, processed, and modified by the graphic output of a computer. Accordingly, in some embodiments systems of the present disclosure having digital object conjugate masks may further comprise a computer. In operation, dynamic masks may allow the rapid fabrication of extensive, three-dimensional microstructures by coordinating the sequential display of digital masks defining portions of a larger structure with vertical positioning of the fabrication substrate relative to the region of fabrication of each corresponding section. Further, portions can be fabricated side-by-side on a substrate having features corresponding to a digital mask by coordinating the sequential display of varying digital masks with horizontal translation of fabrication material. In this way, structures of arbitrary 2D and 3D complexity may be rapidly fabricated from an array of masks. And structures with dimensions exceeding the dimensions of the fabrication exposure may be fabricated by translating the exposure (e.g., along 2D, 3D coordinates) to the fabrication material (see FIG. 9).

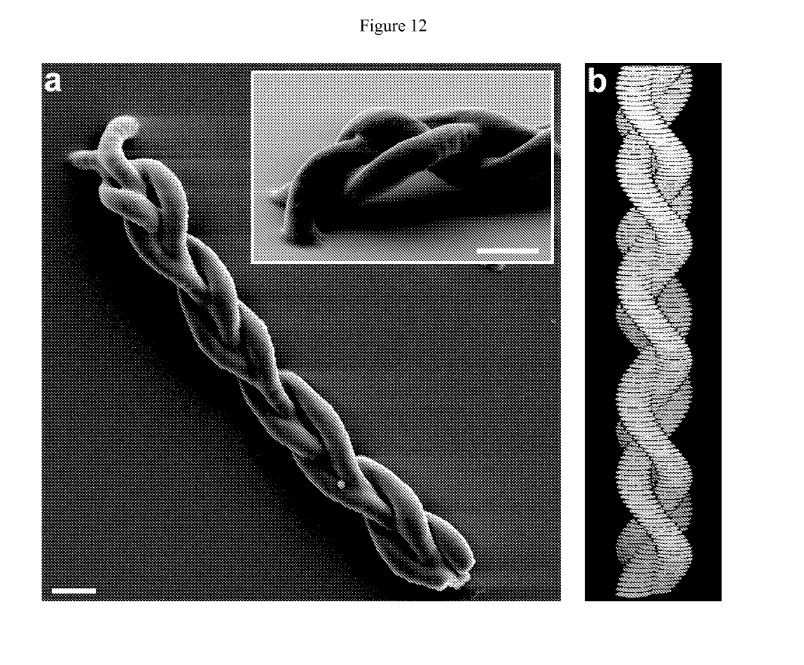

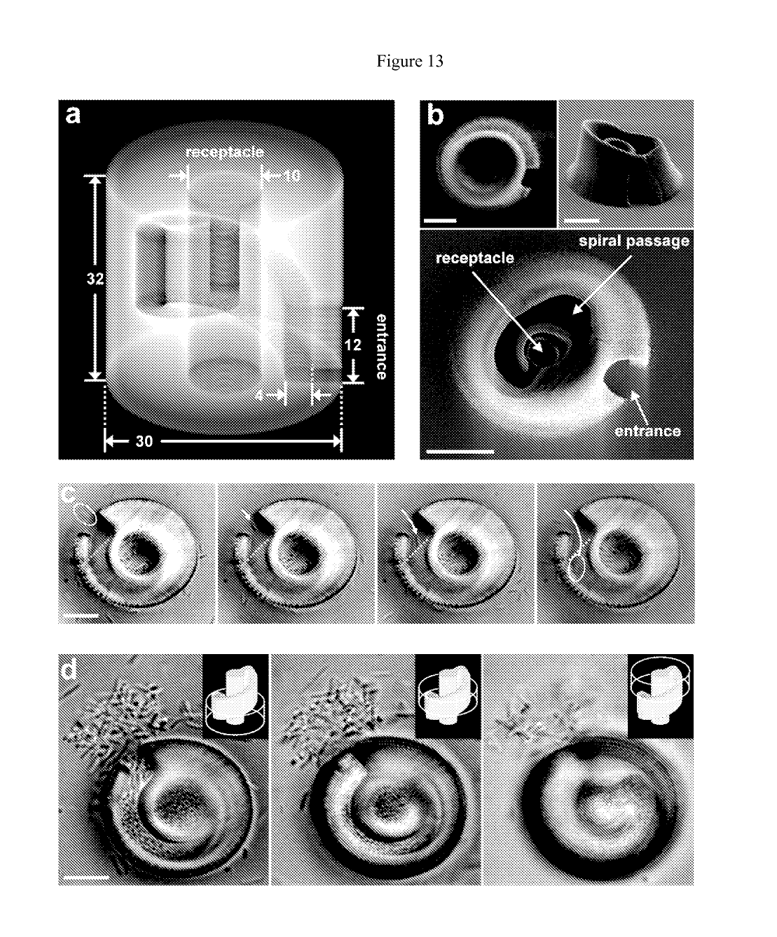

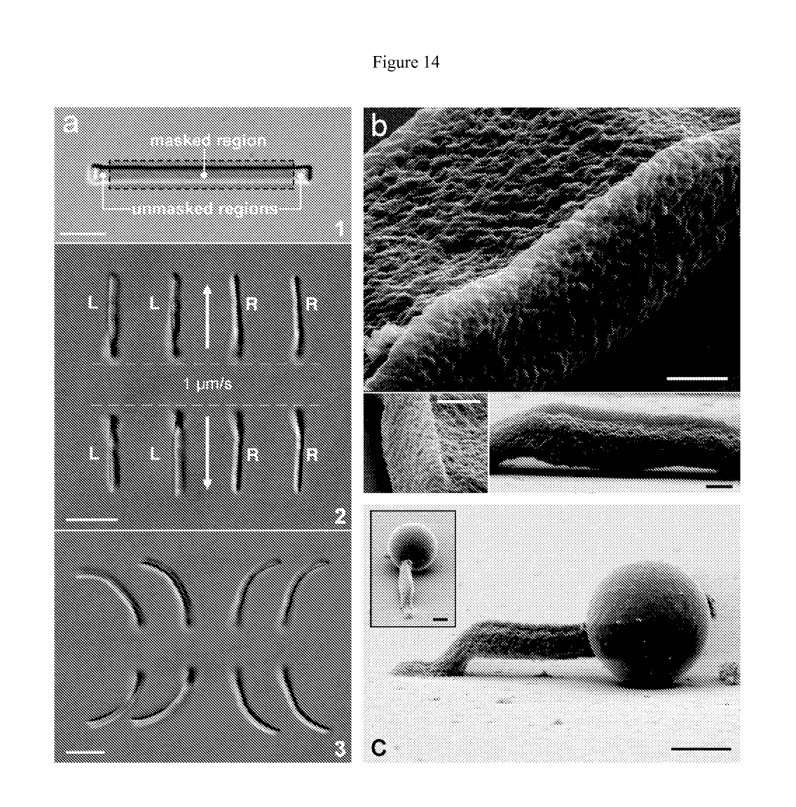

Information directing fabrication may reside within a computer as 3D data, acquired, for example, using a 3D imaging technique. Such techniques include, but are not limited to, x-ray CT scans, magnetic resonance imaging, positron emission tomography, other tomographies, confocal imaging, two-photon and multiphoton imaging, interference-based imaging techniques, and techniques based on sonic and ultrasonic imaging. Such information can be readily stored, for example, as stacks of discrete 2D images, which can be used as sequential masks during fabrication. Alternately, 3D information may be created using other approaches, such as by using 3D computer-aided design, other 3D mapping approaches based on geometric parameters (see FIG. 13), and incremental re-orientation of geometric shapes from one mask to the next in sequence (see FIG. 12). Storage of 3D information is possible on computers remote to the site of fabrication, allowing transfer of fabrication instructions from a repository either during or before the fabrication process.

The magnification device may be any device capable of transferring at least one shape from a conjugate mask to a fabrication material. The magnification device typically has a magnification factor greater than 1, although other magnification factors are contemplated by the present disclosure. As used in this disclosure, magnification factor greater than one refers to a magnification system that reduces the size of the focus in transferring the energy from a conjugate mask to the conjugate plane within the fabrication material. In some embodiments, the magnification device may reduce the size of the shape. This reduction would occur, for example, when common magnifying optics are used to focus light into the fabrication material as opposed to the common practice of collecting light from a specimen, which would lead to an increase in the size of a shape in producing its image. For example, the magnification device may be a lens (e.g., a tube lens) and/or other optic (e.g., a microscope objective lens, such as a high numerical aperture infinity-corrected microscope objective).

The fabrication material may be any light-sensitive material capable of forming a spatially patterned arrangement of altered material. Such materials may be capable of light-induced phase change, either directly from light exposure or through a subsequent development process. The fabrication material chosen will depend, at least in part, on the particular application. Examples of suitable fabrication materials include, but are not limited to, biological materials, photo-curable resins, elastomers, inorganic-organic hybrid polymers, positive photoresists, negative photoresists, metals, and electro-active and catalytic materials. The fabrication material may be a composite of more than one material.

Biological materials may be used as a fabrication material or may be incorporated with a fabrication material. Such biological materials include, but are not limited to, amino acids, peptides, proteins, enzymes, nucleic acids (e.g., RNA, DNA, aptamers, and the like), sugars (e.g., mono- and polysaccharides, carbohydrates, glyco moieties, hyaluronic acid, and the like), and phospholipids. Compositions can further include cell components (e.g., components from a cell digestion), whole biological cells (e.g., bacterial, eukaryotic) and groups of cells (e.g., tissues). For example, a fabrication material may comprise a plurality of protein molecules, or may comprise one or more cells disposed within the fabrication material. Such fabrication materials may be used for lithography in the presence of cells.

Fabrication materials further may comprise photo-curable resins (e.g., urethane acrylates, methacrylates, glutarimides, epoxies, and the like), elastomers (e.g., PDMS), inorganic-organic hybrid polymers (OROMOCER), positive photoresists, and negative photoresists (e.g., SU-8). Fabrication materials can further contain metallic, electro-active, and catalytic components (e.g., Au, Ag, Pt, and nanoparticles thereof).

In some embodiments, the system may include a mask translation device that allows the movement of the conjugate mask during fabrication. A mask translation device may be used in conjunction with a stationary transmissive mask (e.g., transparency photomask as in FIG. 5) or reflective mask (e.g., micromirror device). In such systems, 2D and 3D mask objects may be translated and/or rotated during fabrication thereby changing the area of energy exposure to the fabrication material. Further the fabrication plane can be translated (along x,y,z coordinates) using a fabrication material translation device in conjunction with mask object translation, for example, to allow fabrication of multiple shapes using a single mask or object, as well as to allow defined gradients of material in the fabrication of three-dimensional objects.

In some embodiments the present disclosure provides methods for fabricating microdevices of up to and including three dimensions, comprising: providing an energy source; at least one mask placed in a plane having an approximate one-to-one mapping of spatial positions to the fabrication plane; a magnification device; and a fabrication material; wherein the mask is disposed between the energy source and the magnification device; and wherein the fabrication material is disposed operable to the magnification; and exposing the fabrication material to energy emitted from the energy source.

The ability of the DMD to rapidly switch masks with correct alignment could lead to procedures for increasing the spatial resolution of the fabricated structures. The DMD could be used to display a series of masks where individually a mask did not correspond to the microstructure fabricated at a given plane, but, where a sequence of masks would result in the designed structure. For instance, mask features designed to produce structures near the limits of resolution of the system may, because of the chemical and optical limitations that define the minimum feature size, result in structures that are reproduced with only partial fidelity. However, by using a series of masks that emphasized different portions of the designed object instead of a single mask, the designed microstructure could be accurately reproduced.

As mentioned above, the fabrication material may comprise one or more cells disposed within the fabrication material. Thus, in certain embodiments, the present disclosure provides method for culturing one or more cells, comprising: providing an energy source; a conjugate mask; a magnification device; and a fabrication material and one or more cells;

wherein the conjugate mask is disposed between the energy source and the magnification device; and wherein the fabrication material is disposed operable to the magnification; exposing the fabrication material to energy emitted from the energy source; and culturing the one or more cells within the microdevice. In some embodiments, the method for culturing one or more cells is performed such that the one or more cells enter the microdevice after the microdevice has been formed. In other embodiments, the method for culturing one or more cells is performed such that the microdevice is formed to enclose the one or more cells as it is formed.

In some embodiments, the methods of the present invention may utilize three-dimensional data encoded in a series of planar images that can be displayed on a conjugate mask, such as an electronically based device. The input data may be generated from imaging of biological specimens, such as cells or tissue, using a three-dimensional imaging technique, such as confocal microscopy, x-ray computed tomography, or magnetic resonance imaging. The position of the fabrication voxel may be shifted to appropriately correspond with the sequence of images/masks such that the topography of the imaged biological specimen is replicated in the fabricated material.

In some embodiments, the sequence of conjugate masks, for example as presented to an electronically based device, is generated using algorithms that represents the three-dimensional topography of a design form, such as a group of braided ropes. The position of the fabrication voxel may be shifted to appropriately correspond with the sequence of images/masks such that the topography of the calculated form is created in the fabricated material.

The present disclosure, according to certain embodiments, also provides compositions formed using the methods and/or systems described about. Such devices include, but are not limited to, optical devices and device components such as those that enable transmission, emission, modulation and detection of electromagnetic radiation (e.g., polarizers, prisms, filters, photonic and harmonic generating crystals, diffractive optical elements, phase masks, light amplification and photon detection devices) as well as those that manipulate the geometric properties of light (e.g., mirrors, lenses, photomasks); mechanical devices and device components including both active elements (power sources, inductors, actuators) and device component architectures (e.g., three-dimensional microelectromechanical devices); fluidic devices including elements for transport of fluids (pumps, valves, mixers) as well as fluidic and device architectures (e.g., junctions of fluid channels such as a T-junction, junctions of fluid-filled and hollow channels such as to form a valve or a pump, 3D microfluidic devices); electrical devices including conductive, semiconductive, and resistive elements (e.g., metallic wires and high dielectric/resistive materials; capacitors, diodes, transistors, resistors and the like); chemical and biological devices for the development and manipulation of cells, tissues, and cell/tissue analogues (e.g., cell incubators and scaffolds, cell and tissue replicas and the like), devices and substrates having chemical and topographic cues that promote, resist, and/or have no substantial effect on interaction with additional (secondary) binding elements including but not limited to a chemical element (i.e., of a particular elemental identity, isotope, redox state, etc.), molecule, polymer (e.g., polysaccharide, polypeptide), biological cell (e.g., bacterial, eukaryotic cell), tissue or collection of cells, or a substrate. Further, the interaction with the secondary element may provide a synergistic functionality between the two elements (e.g. modulation of chemical, mechanical, electrical or electromagnetic behavior) that may enable detection/measurement of the secondary element (e.g., chemical or biological sensor) and may further allow binding of additional elements (i.e. tertiary, quaternary, etc. such as an nucleotide/peptide/protein array). The above embodiments may further be implemented in an array comprised of one or more of the above elements (e.g., an array of optical, mechanical, fluidic, electrical, chemical/biological scaffold or sensor, lab on a chip, or combination thereof).

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

### EXAMPLES

Materials. Methylene blue (M-4159) and flavin adenine dinucleotide (FAD, F-6625) was supplied by Sigma-Aldrich (St. Louis, Mo.). Bovine serum albumin (BSA, BAH64-0100) was supplied by Equitech-Bio (Kerrville, Tex.). Avidin (A-887) and fluorescein biotin (B-1370) were supplied by Molecular Probes, (Eugene, Oreg.). All chemicals and solvents were stored according to supplier's specifications and used without further purification. Office grade transparency film for laser printers was used to produce photomasks on an HP Laser Jet 2100TN.

Strains. E. coli strains RP437 (wild-type, wt) and RP9535 (smooth-swimming, ΔcheA), kindly provided by John S. Parkinson (Department of Biology, University of Utah), were grown aerobically in tryptone broth (32° C.) and harvested at mid-log phase. Cells were diluted 20-100 fold into PBS (10 mM potassium phosphate, pH 7.0) for experiments with fabricated microchambers.

Matrix fabrication. Matrixes composed of photo-crosslinked protein were fabricated onto untreated #1 microscope cover glass using the output of a mode-locked titanium:sapphire laser (Tsunami; Spectra Physics, Mountain View, Calif.) operating at 730 to 740 nm. The laser beam was raster scanned into rectangular patterns using a confocal scanner (BioRad MRC600) and brought to focus between the scanbox and the microscope. Placing masks in this focal plane (referred to in the text as the ‘mask plane’) allowed the greatest fidelity in the fabricated object since the mask plane is conjugate with the microscope specimen plane, although masks could be used (with less edge resolution) when placed at any position between the scanbox and the microscope (18 cm). For example, the Texas-shaped micro-gradient in FIG. 1B was fabricated using two masks simultaneously: a negative photo mask used to define the gradient edges was placed in the mask plane while a second, straight-edged fully opaque mask was translated during fabrication approximately 7.5 cm outside of the mask plane. Masks were aligned manually by adjusting the XY position of the mask during test photofabrication procedures. Moving masks were generally translated at a linear velocity of 100 to 200 μm s-1 using rectangular scan frequencies (the inverse of the time to complete a raster-scanned rectangle) of 3 Hz.

The laser output was adjusted to approximately fill the back aperture of an oil-immersion objective (Zeiss 100× Fluar, 1.3 numerical aperture) situated on a Zeiss Axiovert inverted microscope system. Desired powers (30-40 mW before the back aperture of the microscope objective) were obtained by attenuating the laser beam using a half-wave plate/polarizing beam splitter pair. To extend structures along the z dimension (i.e., along the optical axis), the position of the laser focus was translated manually within fabrication solutions using the microscope fine focus adjustment. By removing the mask once the desired structure height was attained, microchambers could be readily sealed from the top with closed rectangular roofs. Typical microchambers having heights of 2-10 μm were produced by allowing two full scans to be rastered across the sample per micron of vertical travel. This procedure allows fully formed 3D objects to be fabricated on time scales of 10-30 seconds.

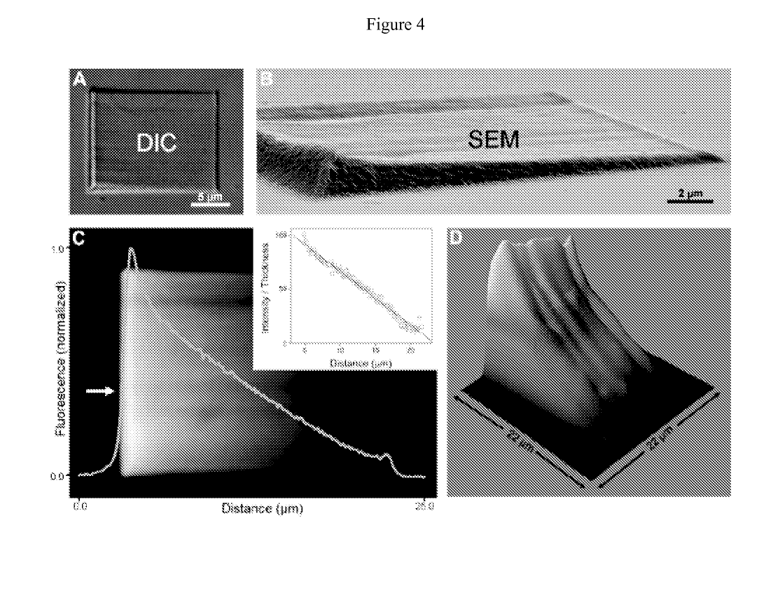

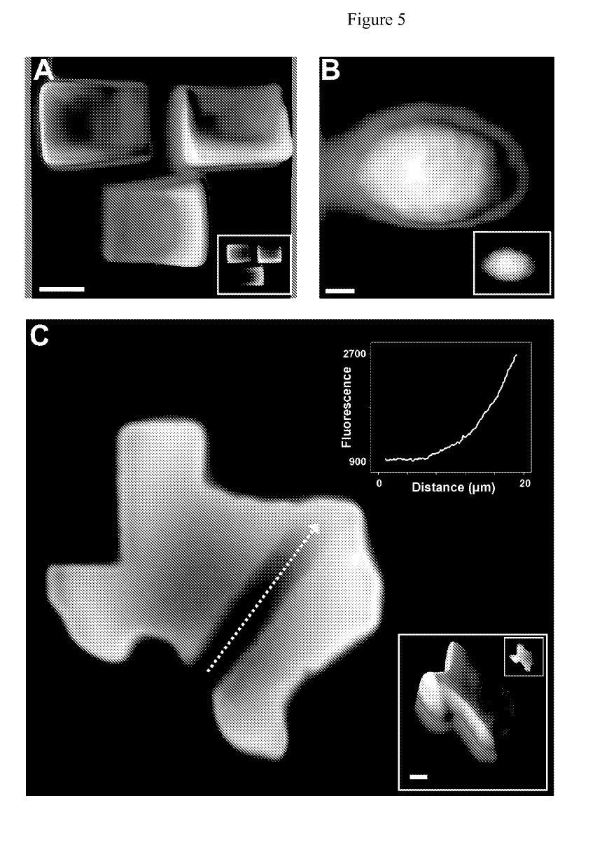

Microstructures composed of photo-cross-linked BSA were fabricated from solutions containing protein at 320-400 mg mL-1 and 2-3 mM methylene blue as a photosensitizer. For biocompatible fabrication (e.g., FIG. 2), flavin adenine dinucleotide (5 mM) was used as the photosensitizer. The practical (lateral) resolution that could be achieved for microstructures in these studies, ˜0.5 μm, was lower than we have achieved in some previous instances for protein photocrosslinking, a result of the mask quality, the speed at which structures were fabricated, and, in the case of the SEM images, the preparation process for imaging. As typical for high-numerical aperture multiphoton excitation, the voxel is somewhat elongated in the vertical dimension. When microstructure fabrication required focusing vertically through a significant thickness of previously photocrosslinked protein resolution was diminished further. Heterogeneity in protein thickness for microstructures shown in FIG. 4 and the Supporting Figure is likely the result of artifacts in the scanning process, as they also are observed in some cases where no mask is used.

Matrix fabrication with digital micromirror device. The output from a mode-locked titanium sapphire laser (Spectra-Physics, Tsunami) tuned to 730-740 nm was aligned into a confocal scan box (Biorad, MRC600) where galvanometer-driven mirrors scanned the beam in a raster pattern. A digital micromirror device (DMD) was placed at the intermediate image plane conjugate to the front focal plane of a high numerical aperture objective. The DMD used in these experiments (Texas Instruments, 0.55SVGA) was a component of a partially dismantled business projector (Benq, MP510). The reflective surface of the DMD was an 848×600 array of 16 μm×16 μm aluminum mirrors. Each individual mirror could switch between “on” and “off” states corresponding to a ±10° tilt angle. The individual mirrors were controlled by the intact projector electronics which were programmed to display (by modulating between the off and on states) the graphic output of a computer. A 15.2 cm focal length lens focused the laser onto the DMD which resulted in an estimated beam diameter on the chip face of ˜30 μm. The beam spot scanned over approximately a quarter of the DMD mirrors. The DMD reflectivity when duplicating a white display was ˜40%. Light reflected down the optical path was collimated by a 15.2 cm focal length tube lens and sent into an inverted microscope (Zeiss Axiovert). A Zeiss Fluar, 100×/1.3 NA, oil immersion objective was used.

Digital information for structures. The system for microfabrication with a DMD could be used to quickly build complex 3D microstructures in a process that required no specific programming from input data that required minimal processing. The information of each fabricated plane could be contained in digital images that can come from sources including, but not limited to: images derived from X-ray computed tomographic data, images defined by three-dimensional models created with computer-aided design software and subsequently sectioned into individual planes, mathematically defined geometrical images displayed with graphics software that can sequentially change in a stepwise manner to define slice data for a three-dimensional microstructure, or images from optical slice data acquired by means of multiphoton or confocal microscopy.

Cell incubation in BSA microchambers. After fabricating the protein plug to trap a single bacterium in a microchamber (FIG. 2D panel 2; chamber dimensions, 10×10×4 μm), the cell was incubated at ambient temperature (22° C.) in tryptone broth in 1 mL dish. The media was replaced at approximately 6-hour intervals and the microchamber was monitored over a period of 3 days.

Fluorescence microscopy. Wide-field fluorescence imaging was performed on the Axiovert microscope, which was equipped with a mercury-arc lamp and standard “red” and “green” filter sets (Chroma, Rockingham, Vt.). Fluorescence emission was collected using the Fluar 100× objective and detected using a 12-bit 1392×1040 element CCD (Cool Snap HQ; Photometrics, Tucson, Ariz.). Data were processed using Image J and Metamorph (Universal Imaging, Sunnyvale, Calif.) image-analysis software.

Scanning electron microscopy (SEM) preparation. Samples were fixed in 3.5% gluteraldehyde solution for 20 min and dehydrated by using 10-min sequential washes (2:1 ethanol/H₂O; twice in 100% ethanol; 1:1 ethanol/methanol; 100% methanol; all solutions stated as v/v), allowed to air-dry for 3 h, and sputter-coated to a nominal thickness of 12-15 nm with Au/Pd.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

1. A system comprising: an energy source; at least one conjugate mask; a magnification device; and a fabrication material; wherein the at least one conjugate mask is disposed between the energy source and the magnification device; and wherein the fabrication material is disposed operable to the magnification device.

2. The system of claim 1, wherein the energy source is a laser.

3. The system of claim 1, wherein the at least one conjugate mask is a static mask.

4. The system of claim 1, wherein the at least one conjugate mask is a dynamic mask.

5. The system of claim 1, wherein the at least one conjugate mask is reflective or a transmissive or both.

6. The system of claim 1, wherein the at least one conjugate mask comprises regions of greater and lesser transmission.

7. The system of claim 1, wherein the at least one conjugate mask is a digital micromirror device.

8. The system of claim 1, wherein the at least one conjugate mask is a liquid crystal display.

9. The system of claim 1, further comprising a computer.

10. The system of claim 1, wherein the magnification device comprises a lens.

11. The system of claim 1, wherein the magnification device comprises a microscope objective.

12. The system of claim 1, wherein at least a portion of the fabrication material is chosen from one or more of a biological material, a photo-curable resin, an elastomer, an inorganic-organic hybrid polymer, a positive photoresist, a negative photoresists, a metal, and an electro-active and catalytic material.

13. The system of claim 1, further comprising a beam scanning device.

14. The system of claim 1, further comprising a mask translation device.

15. The system of claim 1, further comprising a fabrication material translation device.

16. A method comprising: providing an energy source; at least one conjugate mask; a magnification device; and a fabrication material; wherein the at least one conjugate mask is disposed between the energy source and the magnification device; and wherein the fabrication material is disposed operable to the magnification; and exposing the fabrication material to energy emitted from the energy source.

17. The method of claim 16, wherein the energy source is a laser.

18. The method of claim 16, wherein the at least one conjugate mask is a static mask.

19. The method of claim 16, wherein the at least one conjugate mask is a dynamic mask.

20. The method of claim 16, wherein the at least one conjugate mask is reflective or a transmissive or both.

21. The method of claim 16, wherein the at least one conjugate mask comprises regions of greater and lesser transmission.

22. The method of claim 16, wherein the at least one conjugate mask is a digital micromirror device.

23. The method of claim 16, wherein the at least one conjugate mask is a liquid crystal display.

24. The method of claim 16, wherein the magnification device comprises a lens.

25. The method of claim 16, wherein the magnification device comprises a microscope objective.

26. The method of claim 16, wherein at least a portion of the fabrication material is chosen from one or more of a biological material, a photo-curable resin, an elastomer, an inorganic-organic hybrid polymer, a positive photoresist, a negative photoresists, a metal, and an electro-active and catalytic material.

27. The method of claim 16, wherein the fabrication material comprises one or more cells.

28. The method of claim 16, wherein the energy from the energy source is scanned.

29. The method of claim 16, wherein the at least one conjugate mask may be translated or rotated or both during fabrication.

30. The method of claim 16, wherein a fabrication plane may be translated or rotated or both during fabrication.

31. A method comprising: providing an energy source; at least one conjugate mask; a magnification device; and a fabrication material comprising one or more cells; wherein the conjugate mask is disposed between the energy source and the magnification device; and wherein the fabrication material is disposed operable to the magnification device; exposing the fabrication material to energy emitted from the energy source to form a patterned fabrication material; and culturing the one or more cells within the patterned fabrication material.

32. The method of claim 31, wherein at least a portion of the fabrication material is chosen from one or more of a biological material, a photo-curable resin, an elastomer, an inorganic-organic hybrid polymer, a positive photoresist, a negative photoresists, a metal, and an electro-active and catalytic material.

33. The method of claim 31, wherein the energy from the energy source is scanned.

34. The method of claim 31, wherein the at least one conjugate mask may be translated or rotated or both during fabrication.

35. The method of claim 31, wherein a fabrication plane may be translated or rotated or both during fabrication.

36. (canceled)

37. (canceled)
